(19) United States
(12) Patent Application Publication
(10) Pub. No.: US 2026/0278708 A1
(43) Pub. Date: Sep. 17, 2026

(54) REAL ESTATE INFORMATION SYSTEM

(71) Applicant: Charles Isgar, Scottsdale, AZ (US)

(72) Inventor: Charles Isgar, Scottsdale, AZ (US)

(21) Appl. No.: 19/668,220

(22) Filed: May 5, 2026

Related U.S. Application Data
(63) Continuation of application No. 17/890,420, filed on Aug. 18, 2022, now abandoned.
(60) Provisional application No. 63/234,353, filed on Aug. 18, 2021.

(51) Int. Cl. G06Q 50/16; G06F 16/29

(52) U.S. Cl. CPC G06Q 50/16; G06F 16/29

(57) ABSTRACT

A real estate information system is provided. The system operates to provide interaction regarding homes for sale allowing users to obtain information regarding a property that is geo-based for that property and engage is immediate obtaining information and/or viewing of the property through standard messaging applications.

### CROSS REFERENCE TO RELATED APPLICATION[S]

This application is a continuation of U.S. patent application Ser. No. 17/890,420, filed Aug. 18, 2022, which claims priority to U.S. Provisional Patent Application Ser. No. 63/234,353, filed Aug. 18, 2021, the disclosures of which are hereby incorporated entirely herein by reference.

### BACKGROUND OF THE INVENTION

### Technical Field

This invention generally relates to a real estate information system, and specifically to a system for interaction regarding homes for sale allowing users to obtain information regarding a home that is geo-based for that home and engage in immediate obtaining of the home for sale through standard messaging applications.

### State of the Art

Home sales now take advantage of the internet allowing individuals to look at listing and search or homes for sale based on city, town, zip code and the like. Individual potential home buyers can search these online systems in a conventional way of entering the city, town, or zip code and the system returns homes for sale in that city, town or zip code. If an individual wants to see what homes are for sale in particular neighborhood, if the individual is actually in that neighborhood. The individual can drive around and look for “FOR SALE” signs. These systems and conventional means of finding homes for sale do not allow for determining whether you are in proximity of an available home for sale or have a mechanism for immediate viewing of the property with immediate entrance into the home. Additionally, these systems require a user to utilize the application or website provided by the real estate agent or the like in order to engage in obtaining of property information or viewing the property.

Accordingly, what is needed is a real estate information system that addresses the shortcomings of existing home sales information systems/platforms.

### SUMMARY OF THE INVENTION

An embodiment includes a real estate information system based on geolocation, the system comprising: a server having a memory storing geo-tagged property data; and a user computing device coupled to the server, wherein the server is programmed to: receive location information from the user computing device; automatically process the location information and determine what properties have a geolocation near the geolocation of the at least one user computing device and establish a proximity zone around each of the properties; automatically find and retrieve geo-tagged property data corresponding to the properties near the geolocation of the at least one user computing device; automatically deliver a portion of the geo-tagged property data to the user computing device as a message delivered on a standard messaging application operating on the user computing device with a prompt to send a reply message for obtaining additional geo-tagged property data; and receive the reply message and deliver additional geo-tagged property data to the user computing device as a message delivered on the standard messaging application operating on the user computing device.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 a diagrammatic view of a real estate information system according to an embodiment;

FIG. 2 depicts a user computing device operating in a real estate information system according to an embodiment;

FIG. 3A depicts a user computing device operating in a real estate information system according to an embodiment;

FIG. 3B depicts a user computing device operating in a real estate information system according to an embodiment;

FIG. 3C depicts a user computing device operating in a real estate information system according to an embodiment;

FIG. 3D depicts a user computing device operating in a real estate information system according to an embodiment;

FIG. 3E depicts a user computing device operating in a real estate information system according to an embodiment;

FIG. 3F depicts a user computing device operating in a real estate information system according to an embodiment;

FIG. 3G depicts a user computing device operating in a real estate information system according to an embodiment;

FIG. 4A depicts a user computing device operating in a real estate information system according to an embodiment;

FIG. 4B depicts a user computing device operating in a real estate information system according to an embodiment;

FIG. 4C depicts a user computing device operating in a real estate information system according to an embodiment;

FIG. 4D depicts a user computing device operating in a real estate information system according to an embodiment;

FIG. 4E depicts a user computing device operating in a real estate information system according to an embodiment;

FIG. 4F depicts a user computing device operating in a real estate information system according to an embodiment;

FIG. 4G depicts a user computing device operating in a real estate information system according to an embodiment;

FIG. 5A depicts a user computing device operating in an optional manner from FIG. 3B in a real estate information system according to an embodiment; and

FIG. 5B depicts a user computing device operating in an optional manner from FIG. 3B in a real estate information system according to an embodiment.

### DETAILED DESCRIPTION OF EMBODIMENTS OF THE INVENTION

As discussed above, embodiments of the present invention relate to system for interaction regarding real estate sales allowing users to obtain information regarding a property that is geo-based for that property and engage is immediate information and/or viewing of the property through standard messaging applications. The system may include the use of a mobile application operating on a user computing device that may be a mobile computing device like a smartphone, a tablet, a wearable, and the like.

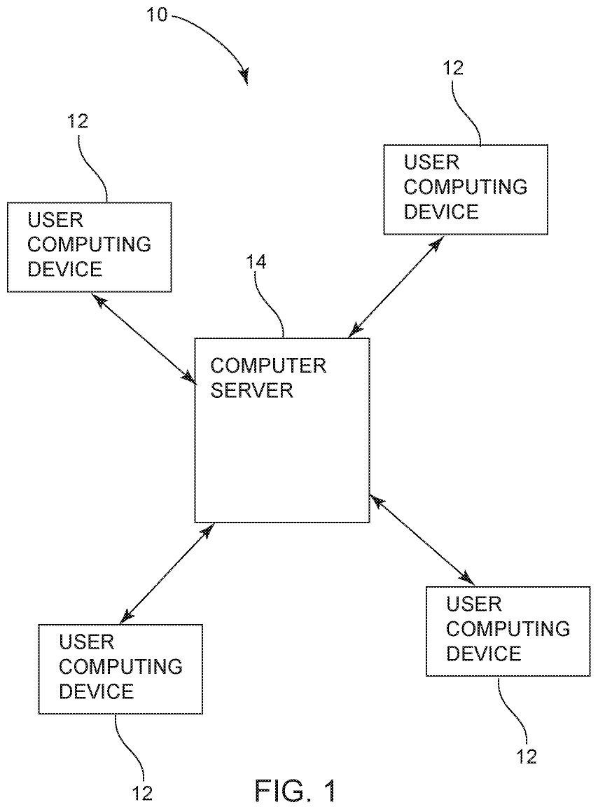

FIG. 1 depicts an embodiment of a real estate information system 10 for interaction regarding real estate sales based on geolocation. The system 10 may include user computing devices 12 and a server 14, wherein each user computing device 12 is coupled to the computer server 14. This coupling may be a network connection, such as a wireless connection through an Internet connection, a Wi-Fi connection, a Bluetooth connection or the like, wherein the user computing devices 12 may communicate with and receive communication from the server 14. The user computing device 12 may include a desktop computer, a laptop, a tablet, a smartphone, a vehicle-installed computing device and the like. The server 14, in some embodiments, may be a computer server or a cloud-based infrastructure architecture. This system 10 may be integrated into an existing vacation rental platform or may be a stand alone system that access multiple vacation rental platforms.

The server 14 may include a memory storing various property data. The memory of the server 14 may store location information corresponding to a particular property, listed price and amenities of the property and stored as a geo-tagged property data.

The user computing device 12 may be coupled to the server 14, and may be programmed to receive location information from the user computing device; automatically process the location information and determine what properties have a geolocation near the geolocation of the at least one user computing device and establish a proximity zone around each of the properties; automatically find and retrieve geo-tagged property data corresponding to the properties near the geolocation of the at least one user computing device; automatically deliver a portion of the geo-tagged property data to the user computing device as a message delivered on a standard messaging application operating on the user computing device with a prompt to send a reply message for obtaining additional geo-tagged property data; and receive the reply message and deliver additional geo-tagged property data to the user computing device as a message delivered on the standard messaging application operating on the user computing device.

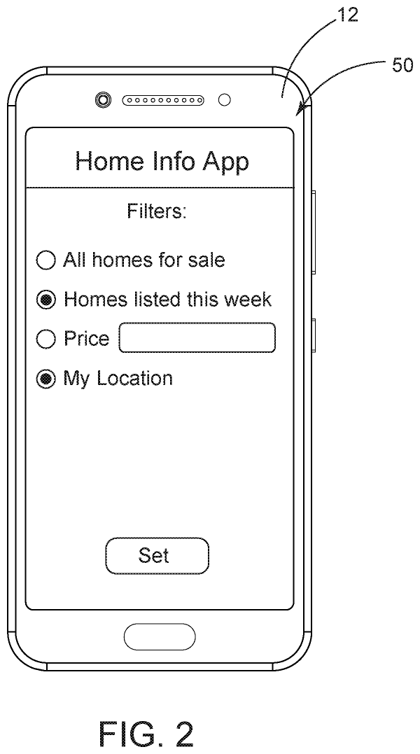

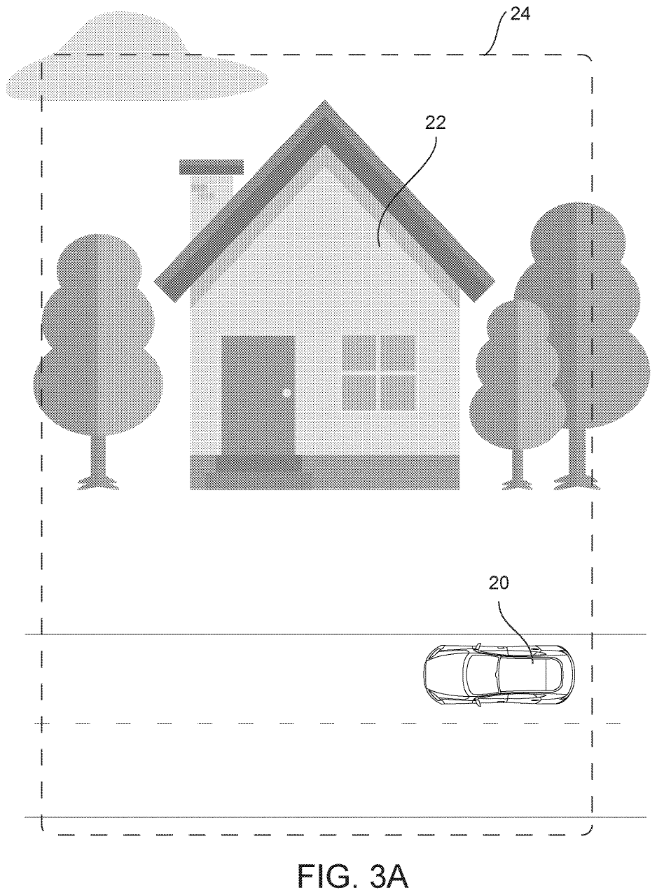

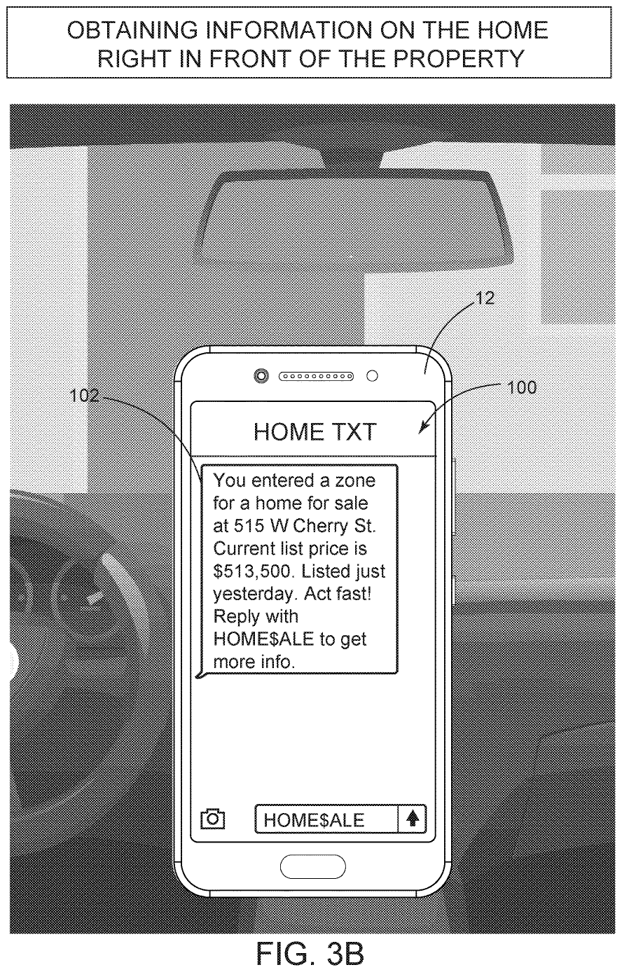

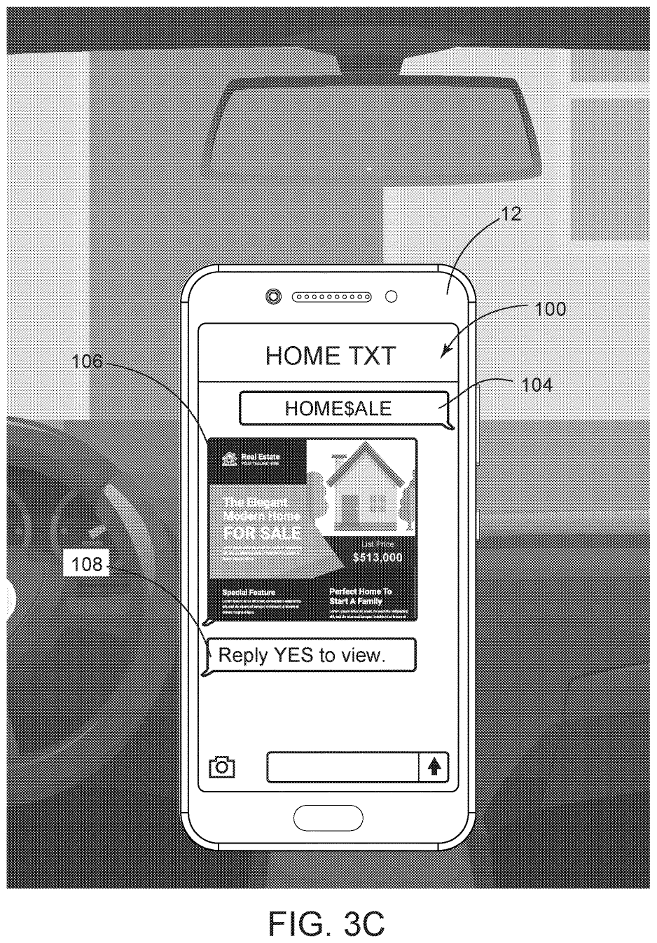

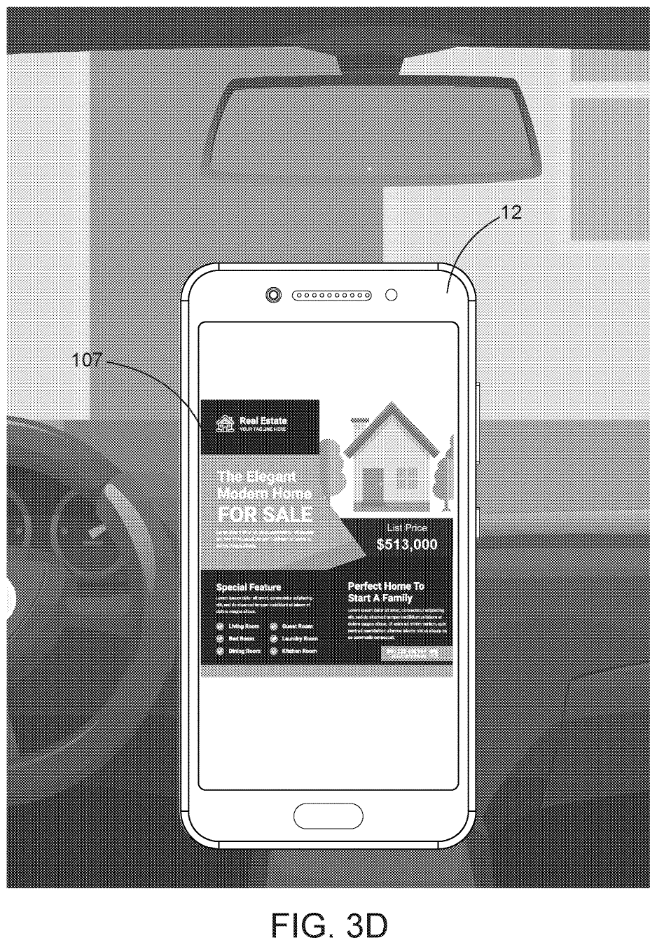

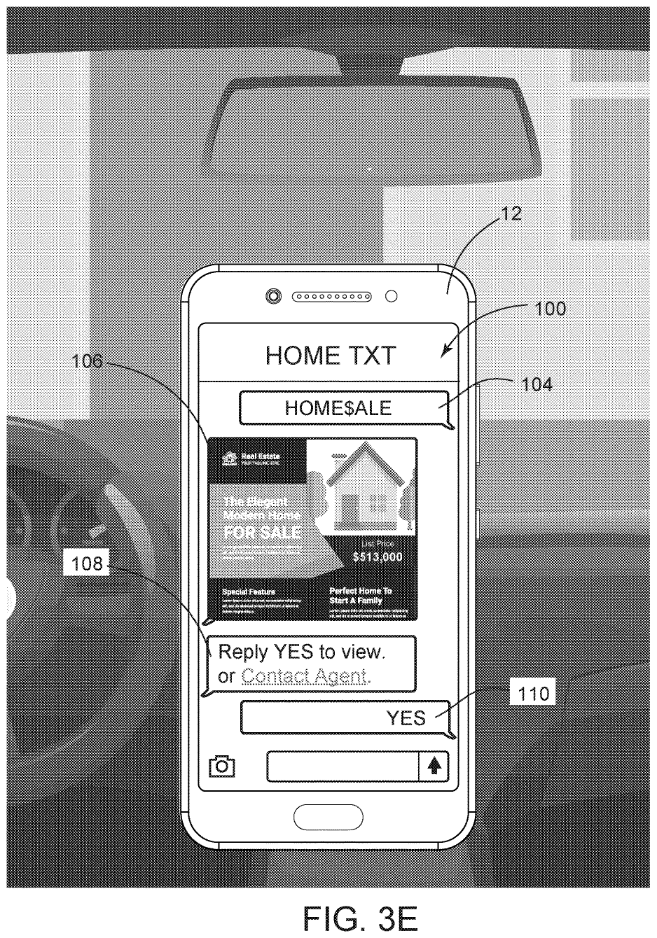

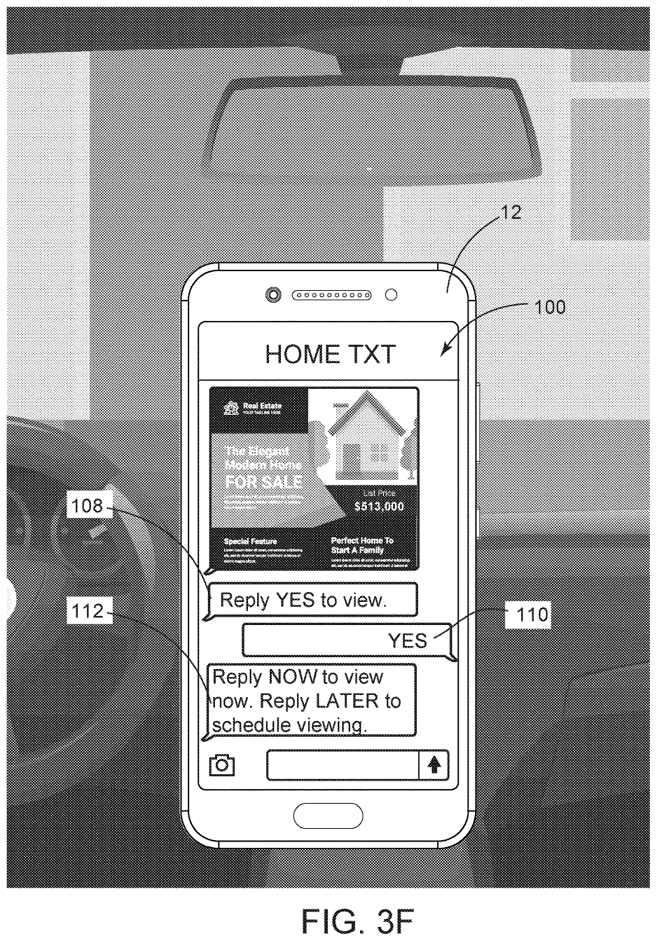

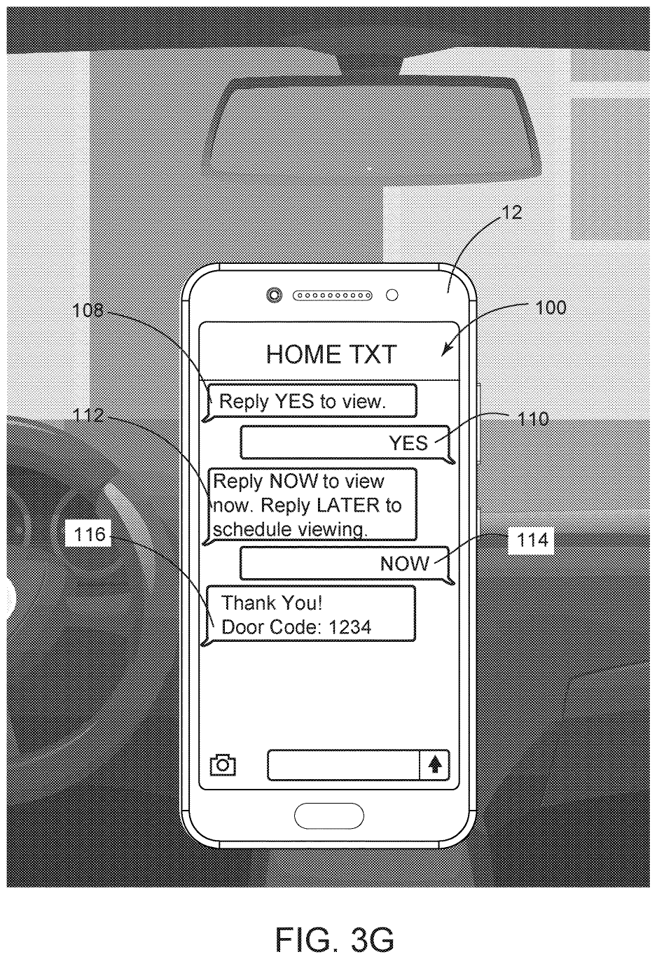

As shown in FIGS. 2-3G, the user computing device 12 may operate an app, a web app or website to access the system 10 and can operate to obtain information and/or view the home within minutes using the real estate information system 10. The user may register to use the system, that includes the at least a mobile phone number or messaging details for the user that can be accessed by the user computing device 12. The user computing device 12 operating the app may set filters for limiting the type of vacation rentals that the user in interested in through user interface 50. Once the filters are set, the mobile app may operate in the background on the user computing device 12. Referring to FIG. 3A, the user computing device 12 may be within vehicle 20 or may otherwise be travelling by walking, bicycle, or other means of transporting from one location to another, and the location of the user computing device 12 may be sent to the server 14. The location may be within a predetermined proximity zone 24 of the geolocation of a property 22 that meet the criteria established by the filters selected by the user.

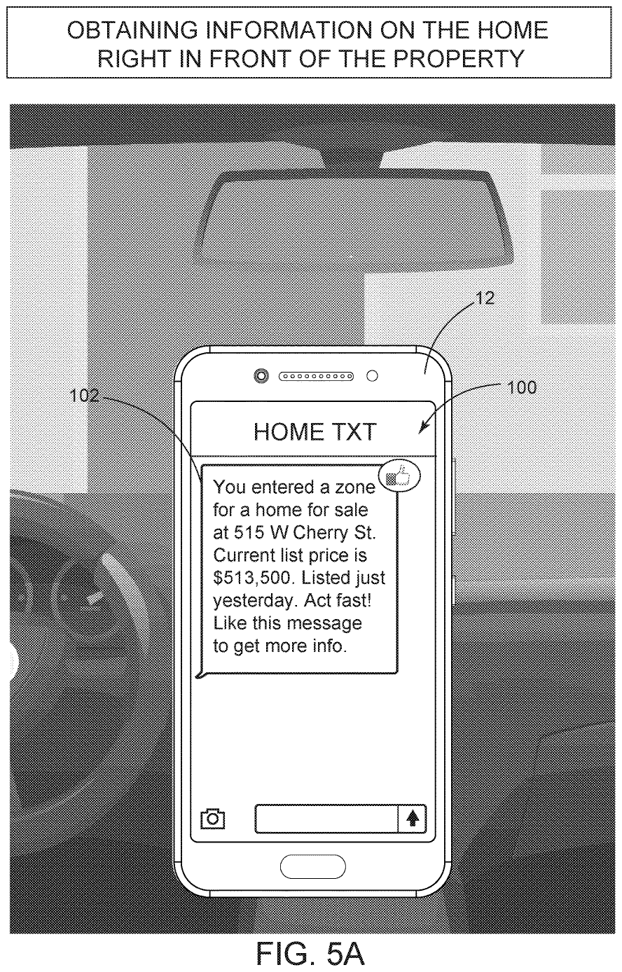

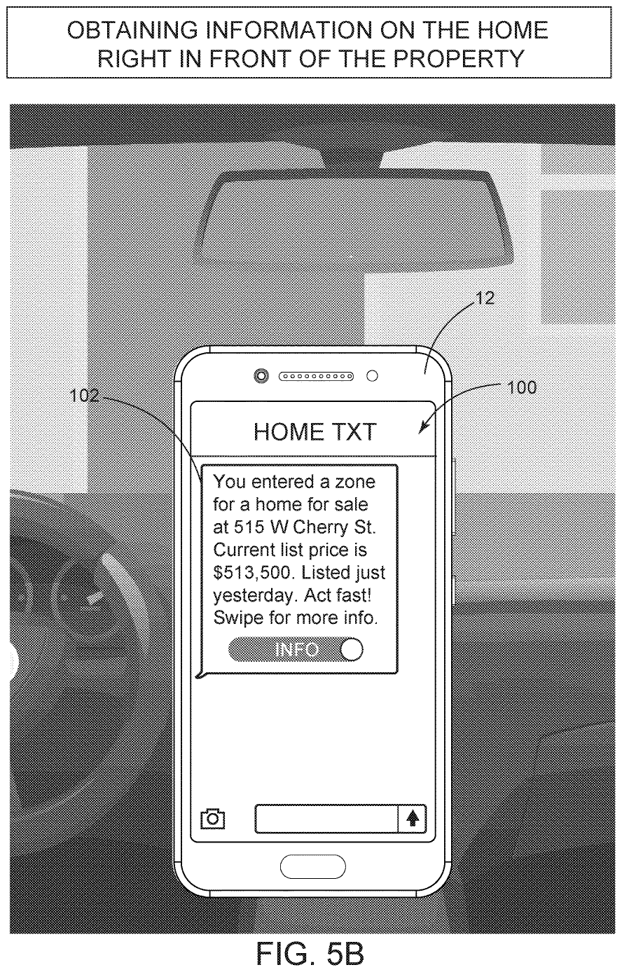

In operation and referring additionally to FIGS. 3B-3G, as the user computing device 12 is determined to be within the proximity zone 24, the server may send a message 102 to the user computing device 12 through a standard messaging application 100 operating on the user computing device 12. The standard messaging application 100 may allow for text messages (SMS), multimedia messages (MMS) and the like. The message 102 may include a portion of the geo-tagged property data, such as, but not limited to an address, a listed price and a prompt to send a reply message in order to obtain additional information. In this instance, the user may pull the vehicle over on in front of the home for sale related to the message and send the reply message, which may be a particular word, such as HOME$ALE as shown in FIG. 3B. In other embodiments, there may be other ways to obtain more information on the home. For example, and without limitation, the user may like the text message, such as a tapback message, as shown in FIG. 5A, to add to obtain additional information or may engage a slider, as shown in FIG. 5B, to add to obtain additional information. The initial reply message 104 may then be received by the server 14 and the server 14 may then send another message 106 that includes additional information and may further send a second prompt 108 to prompt a second reply message from the user. The additional information may include information in the form of text or as an image as depicted in FIGS. 3C-3F, wherein the image may be blown up (see FIG. 3D) and it provides information such as the listed price, the amenities and so forth. The user may then, as shown in FIG. 3E, send a second reply message 110 to the server 14 in response to the second prompt 108, wherein the prompt 108 may be a request for viewing the home and the second response 110 may include an answer to the prompt 108. The user may also select to contact the agent, for example by selecting the hyperlink in the message 108 wherein a text or a call to the agent, as shown in FIG. 3E. The server 14 may then send another message that is a viewing message 112, that may include a prompt requesting a response if the user would like to view the property now or later, as shown in FIG. 3F. The user computing device 12 may then send a third reply message 114 that includes a response to the prompt, such as NOW as shown in FIG. 3G. The server 14 may then send a confirmation message 116 including instructions to enter the home for sale, such as door code, as shown, or the like. The user may utilize the system 10 to obtain information and view the home within minutes and right in front of the property.

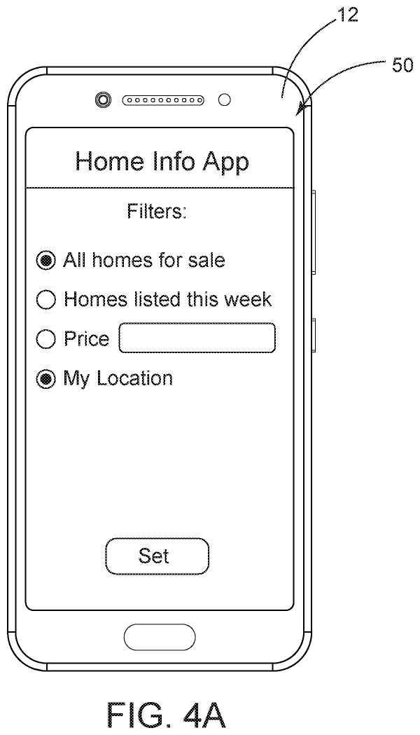

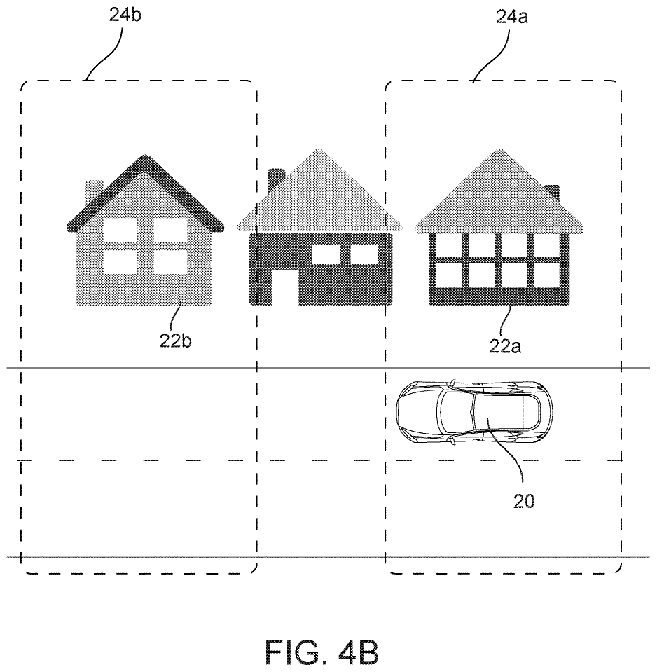

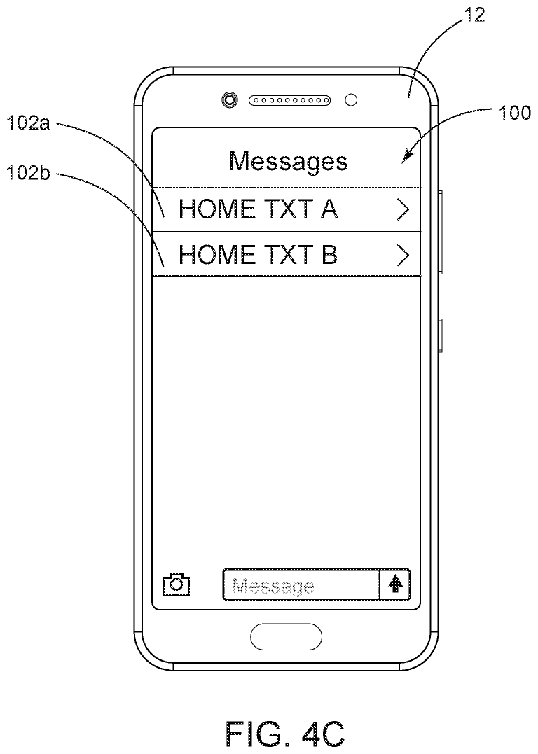

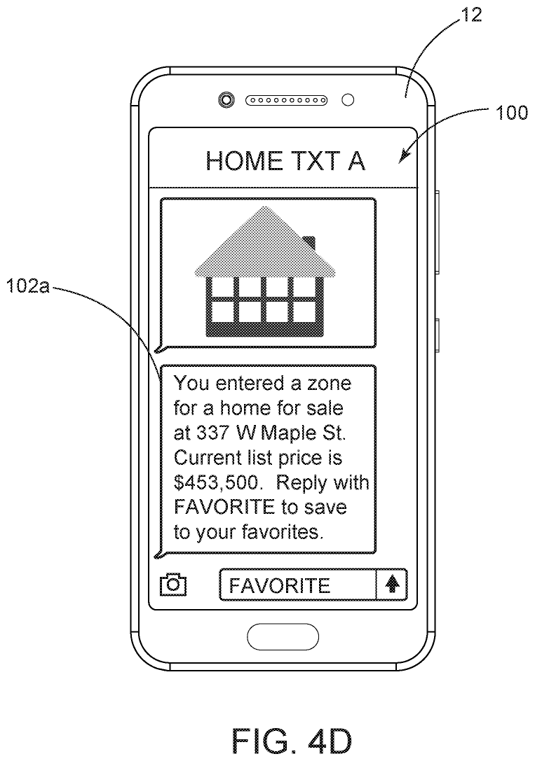

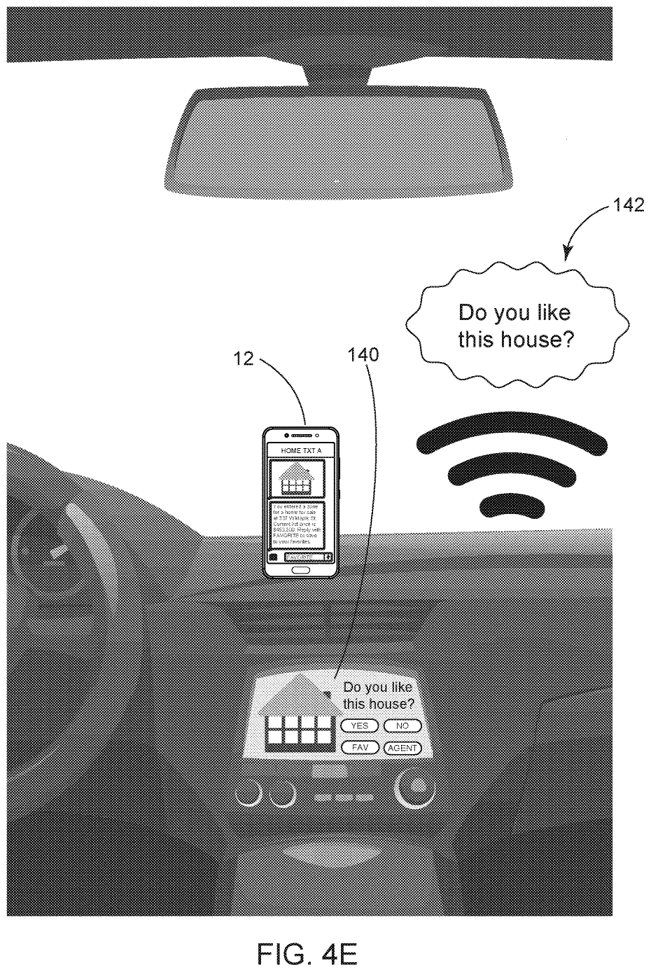

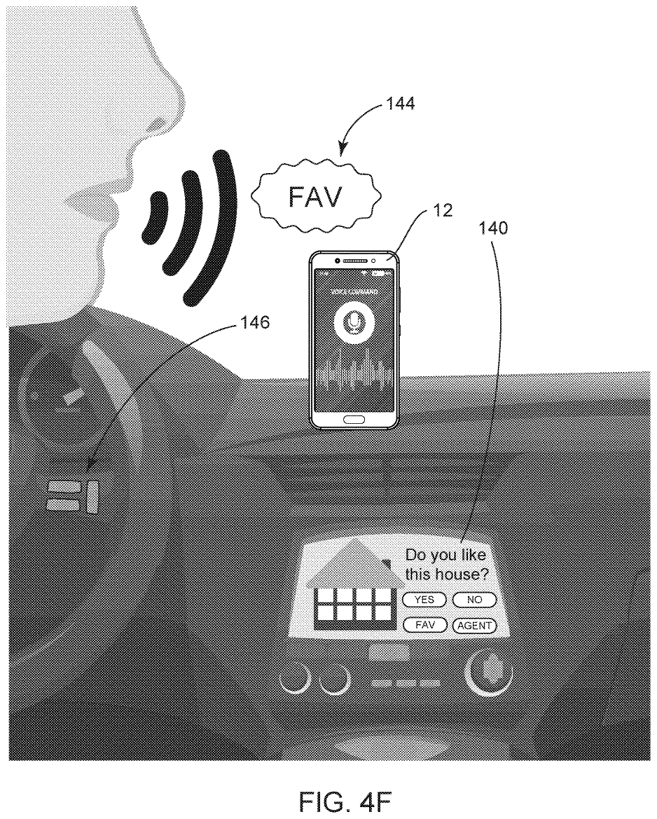

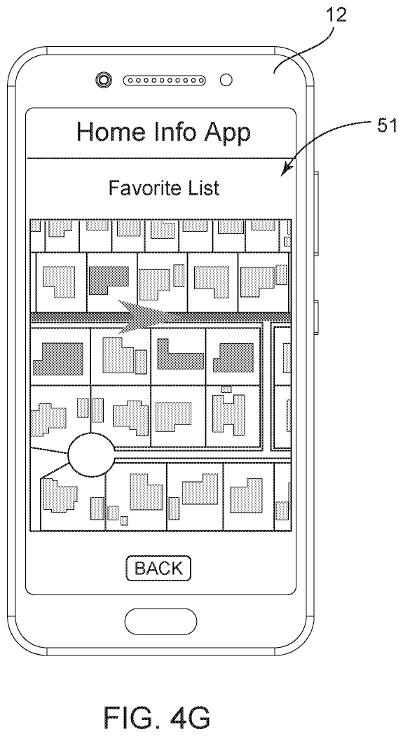

In some embodiments, as shown in FIGS. 4A-4F, the system 10 may include entering filters for all homes for sale. The system 10 operates similar as described in FIGS. 3A-3G, showing the vehicle 20 driving by more than one property 22a and 22b and through more than one proximity zone 24a and 24b, resulting in several text messages 102a and 102b (see FIG. 4C). Selecting each message may direct the user through the same process as shown in FIGS. 3A-3G, or may be used to obtain information about several homes for sale through messaging to add to the user's favorites. For example, the server 14 may send a message 102a to the user computing device 12 that includes a portion of the geo-tagged property information with a prompt to respond in order to add to the user's favorites, such as responding with the text message of FAVORITE as shown in FIG. 4D. It will be understood that in some instances, the user may be driving a vehicle and the user computing device 12 is connected to the computing device of the vehicle. The message may be displayed on the screen 140 of the vehicle 20 as shown in FIGS. 4E and 4F and the user may take action using the screen 140 of the vehicle 20 or to engage buttons 146 of the steering wheel to add to favorites or not. Additionally, the vehicle may be connected to the phone 12 and can notify the user by an audible alert 142 such as the reading of the message. The user may then respond to the audible alert 142 with a verbal response 144 that is registered by the user computing device 12, possibly through the microphone of the user computing device 12 or through the microphone of the vehicle. The audible alert and response may be performed in the car or directly to the device with voice commands. The server 14 may receive such a message and store that property within the memory of the server and identify is as a favorite of the user. The server 14 may, at the request from the user computing device 12, send for display on the user computing device a map having favorite homes for sale designated on the map, such as highlighting them a different color, and the route traveled when passing the homes for sale, as shown in FIG. 4G.

Embodiments may be available on or through the internet, such as through domain names reserved and owned by Applicant that include text-agent.com, text-listing.com, text-mls.com, listingtexts.com, drivebytexts.com, intheneighborhoods.com, icouldlive.com, drivebyrealestate.com or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A real estate information system based on geolocation, the system comprising:
a server having a memory storing geo-tagged property data and filters set by the user for homes for sale; and
a user computing device coupled to the server, wherein the user computing device is associated with a mobile phone number of a registered user and wherein the server is programmed to:
receive continuing location information from the user computing device;
automatically process the location information and determine what properties have a geolocation near the geolocation of the user computing device that meet the criteria of the filters and establish a proximity zone around each of the properties;
automatically find and retrieve geo-tagged property data corresponding to the properties near the geolocation of the user computing device;
in response to the continuing location information of the user computing device being within a proximity zone corresponding to a property, automatically deliver a portion of the geo-tagged property data of the property directly to a native messaging application on the user computing device as a text message using the mobile phone number, wherein the native messaging application accepts SMS and MMS messaging without requiring a specialized real estate application or user login with a prompt to send a reply text message for obtaining additional geo-tagged property data;
receive the reply text message through the native messaging application and deliver additional geo-tagged property data to the user computing device as a text message to the user computing device using the mobile phone number;
in response to receiving a viewing request text message from the user computing device, automatically send a viewing prompt text message through the native messaging application to request whether the user would like to view the property now or later; and
in response to receiving a text message indicating immediate viewing, automatically generate a unique entry code and transmit the unique entry code to a smart lock system at the property, and automatically send entry instructions including the unique entry code for immediate access to the property as a text message through the native messaging application using the mobile phone number.

2. The system of claim 1, wherein the user computing device is connected to a computing device of a vehicle, and wherein the server is further programmed to deliver the portion of the geo-tagged property data as an audible alert through the vehicle, and receive a verbal response from the user through a microphone.

3. The system of claim 1, wherein the server is further programmed to: receive a text message from the user computing device indicating a property should be added to the user's favorites; and store the property within the memory of the server as a favorite of the user.

4. The system of claim 3, wherein the server is further programmed to, in response to a request from the user computing device, send for display on the user computing device a map having favorite properties designated on the map and a route traveled when passing the properties.

5. The system of claim 1, wherein the reply text message comprises at least one of a tapback message to the text message, or a slider interaction with the text message.

6. The system of claim 1, wherein the smart lock system comprises a keypad on a door or a lockbox, and wherein the unique entry code is a randomly generated code that allows temporary access to the property.

7. The system of claim 1, wherein the server is further programmed to communicate the unique entry code to the smart lock system using a wireless signal to a controller operable to unlock a door at the property.

8. The system of claim 1, wherein the user registers to use the system by providing at least the mobile phone number for the user that can be accessed by the user computing device.

9. A system for location-based data retrieval and interaction, comprising a server having one or more processors and memory storing instructions that, when executed, cause the server to:
receive location data from a user computing device;
determine that the user computing device has entered a geofenced region associated with a physical property;
automatically retrieve structured property data associated with the physical property from a data store;
automatically initiate a communication session with the user computing device via a native communication interface without requiring installation of a dedicated application;
transmit a first subset of the structured property data to the user computing device;
receive an interaction signal from the user computing device; and
dynamically select and transmit a second subset of the structured property data based on the interaction signal.

10. The system of claim 9, wherein the native communication interface comprises a messaging application that accepts SMS and MMS messaging.

11. The system of claim 9, wherein the communication session is automatically initiated without requiring user input in response to the user computing device entering the geofenced region.

12. The system of claim 9, wherein the interaction signal comprises a predefined response selected from a tapback message or a slider interaction.

13. The system of claim 9, further comprising instructions that, when executed, cause the server to:
receive a viewing request from the user computing device;
transmit a viewing prompt requesting whether the user would like to view the physical property now or later;
in response to receiving a response indicating immediate viewing, generate an access credential; and
transmit the access credential to the user computing device.

14. The system of claim 13, further comprising instructions that, when executed, cause the server to transmit the access credential to an access control system associated with the physical property.

15. A system for location-triggered structured data delivery via a native messaging application, comprising a server configured to:
receive location data from a user computing device associated with a mobile communication number;
determine that the user computing device is within a geofenced region corresponding to a physical property;
automatically initiate a communication session via a native messaging application associated with the mobile communication number;
retrieve structured property data comprising a plurality of discrete data elements;
transmit a first set of the discrete data elements as a message;
receive a response message corresponding to a predefined interaction; and
select and transmit a second set of the discrete data elements based on the predefined interaction.

16. The system of claim 15, wherein the second set of the discrete data elements comprises at least one of an image of the physical property or amenity information.
